(19) United States
(12) Patent Application Publication
(10) Pub. No.: US 2009/0094735 A1
(43) Pub. Date: Apr. 16, 2009

(54) FOOT BATH WITH DISPOSABLE LINER AND IMPELLER

(75) Inventor: Minh Sang TRAN, Cambridge (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Gulfstream Plastics Ltd., Cambridge (CA)

(21) Appl. No.: 11/871,409

(22) Filed: Oct. 12, 2007

(51) Int. Cl. A47K 3/10; A47K 3/02; A61H 33/00

(52) U.S. Cl. 4/541.1; 4/580; 607/86

(57) ABSTRACT

The tub has a disposable plastic liner configured to the shape of the tub. A pump assembly, having a housing and an electric motor within the housing, drives a drive element. The liner has an opening aligned with the pump assembly, and that opening is sealed around its periphery against the impeller housing of an impeller assembly. The impeller assembly in turn attaches to the pump assembly, preferably in a readily releasable manner such as by the use of magnets. The impeller housing contains an impeller, having a drive shaft which extends through a seal in the rear of the housing and is has a coupling which is engaged by the drive element to rotate the impeller. A cover plate having impeller inlets and outlets attaches to the impeller housing on the tub side of the liner. The entire tub liner and impeller assembly may be removed and disposed of after use.

### BACKGROUND OF THE INVENTION

1. Field of the Invention

This invention relates to foot baths or spas, and in particular to a disposable liner and impeller for use in same.

However, although reference is made throughout to “foot baths”, it should be understood that the invention can be applied to any bath where hygienic problems similar to those described below could arise.

2. Description of the Prior Art

In the tubs of prior art foot baths, water jets commonly have been permanently mounted and may have permanently installed pipes, to circulate water in the tub and to provide streams of water in the tub for therapy and relaxation. For example, there may be a pump installed adjacent to, remote from, or on the tub, with inlet and outlet pipes leading to the tub from the pump location. This can lead to problems of infection or other health issues due to the difficulty of adequately cleaning and sanitizing the pipes between uses. Buildup of algae, fungus, bacteria and mold can be problematic.

A partial solution to this problem involves so-called “no-pipe” or pipeless water jets, which are becoming increasingly common. These are self-contained units, with an impeller and pipeless inlets and outlets, whereby the water is simply drawn into the impeller through one opening or set of openings in a cover plate, for example, and discharged through another opening or set of openings in the same cover plate. Removal of the cover plate provides relatively easy access to the impeller and its housing for cleaning. However, a certain amount of cleaning still is necessary, and the standards being dictated by best practices as well as by regulation and legislation are becoming increasingly stringent. In California now, for example, it is the inventor's understanding that the tub must be drained after each use, filled with fresh water and a cleaning solution, then circulated for 15 minutes, and dried, all before the next spa customer can be accepted. A typical session with a spa client might be a half-hour. When the cleaning process must be employed, it will be appreciated that the spa owner or operator thus can only process one client per hour per spa, instead of two or perhaps three. The impact on profitability is obvious.

### SUMMARY OF THE INVENTION

In view of the above, it is an object of preferred embodiments of the invention to address the above problems. In broad terms, this is accomplished by ensuring that most or all components which come into contact with the tub water are disposable.

According to one aspect of the invention, the tub has a disposable plastic liner configured to the shape of the tub.

Although draining could be effected by other means such as a siphon or pump, preferably the liner has an opening aligning with the drain of the tub, with the opening sealed by a drain plug, plastic flap or other means as will be described later herein. Preferably, to facilitate draining and to ensure a good seal so that drained water contacts only the drain somewhat below the tub, rather than having any contact with the tub, the liner has a somewhat tubular portion at the opening, extending at least partially into the tub drain.

In the preferred embodiment, mounted on a wall of the tub is a pump assembly, having a housing and an electric motor within the housing which drives a drive element. The liner has an opening aligned with the pump assembly, and that opening is sealed around its periphery against an impeller housing. The impeller housing in turn attaches to the pump assembly by any suitable means, preferably a readily releasable means such as by the use of magnets. The impeller housing contains an impeller, having a drive shaft which extends through a seal in the rear of the housing and is engaged by the drive element to rotate the impeller. A cover plate having impeller inlets and outlets attaches to the impeller housing on the tub side of the liner. Thus the entire tub liner, cover plate, impeller and impeller housing may be removed and disposed of after use.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is an exploded perspective view showing a tub and liner according to a preferred embodiment of the invention;

FIG. 2 is an exploded cross-section, showing the tub, liner, pump assembly and impeller assembly;

FIG. 3 is a cross-section similar to FIG. 2, showing the liner installed;

FIG. 4 is a cross-section showing details of the impeller assembly mounted against the pump assembly;

FIG. 5 is an exploded perspective view of the pump assembly and impeller assembly;

FIG. 6 is an exploded perspective view showing the pump assembly positioned for installation in the tub;

FIG. 7 is a perspective view showing the rear of the pump assembly, installed in the tub;

FIG. 8 is an exploded perspective view, showing the impeller assembly ready to be mounted against the pump assembly;

FIG. 9 is a perspective view of a tub with the liner installed, showing an alternative drain cover; and

FIG. 10 is a cross-section showing the alternative drain cover.

### DETAILED DESCRIPTION OF THE INVENTION

In the following description, various embodiments of the present invention wilt be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

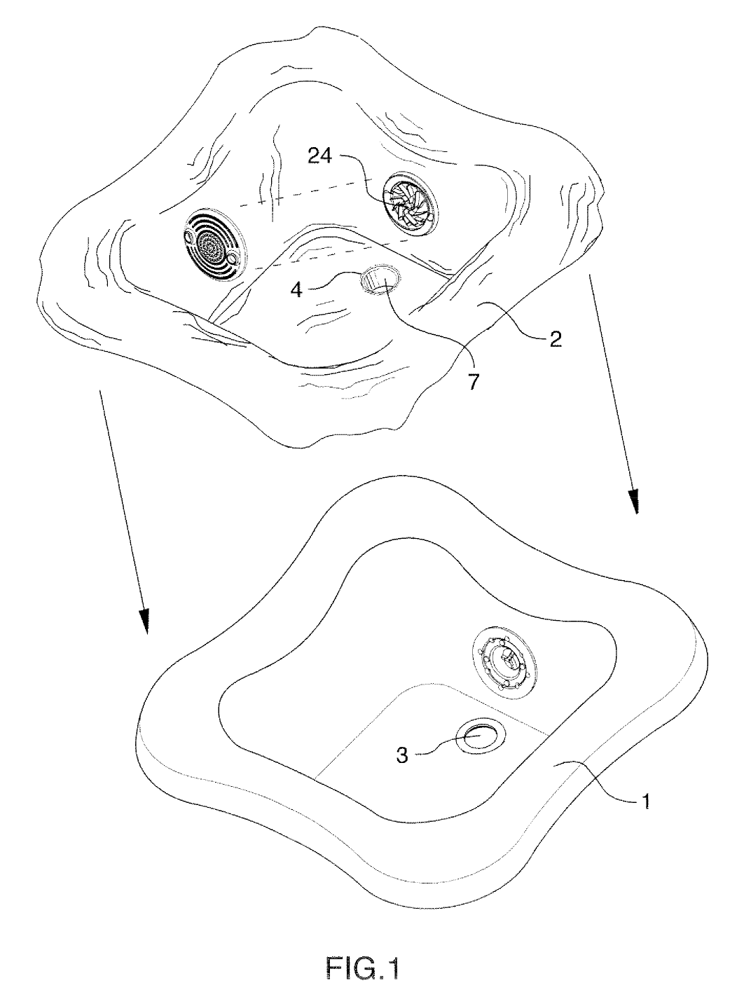

A preferred or exemplary embodiment of the invention is illustrated in the accompanying drawings. FIG. 1 shows a tub 1 ready to receive a disposable plastic liner 2 configured to the shape of the tub.

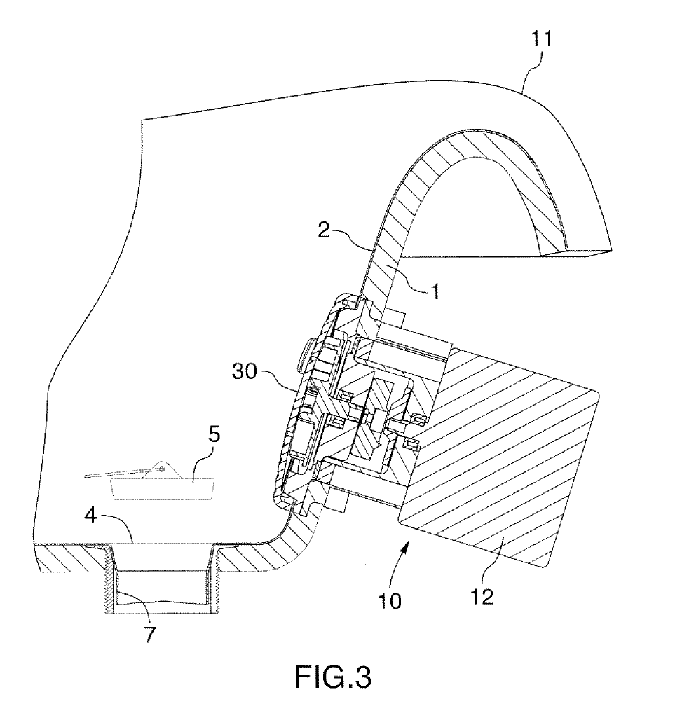

Although the tub and liner do not necessarily have a drain, and draining could be effected by other means such as a siphon or pump, preferably the tub has a drain 3 and the liner has an opening 4 aligning with the drain. The opening and drain can be sealed by a conventional drain plug 5 (see FIG. 3). The drain plug can be easily cleaned and sterilized, or preferably treated as disposable.

Preferably, to facilitate draining and to ensure a good seal so that drained water contacts only the drain somewhat below the tub, rather than having any contact with the tub, the liner has a somewhat tubular portion 7 at its opening 4, extending at least partially into the tub drain 3. This is best seen in FIGS. 1 and 3.

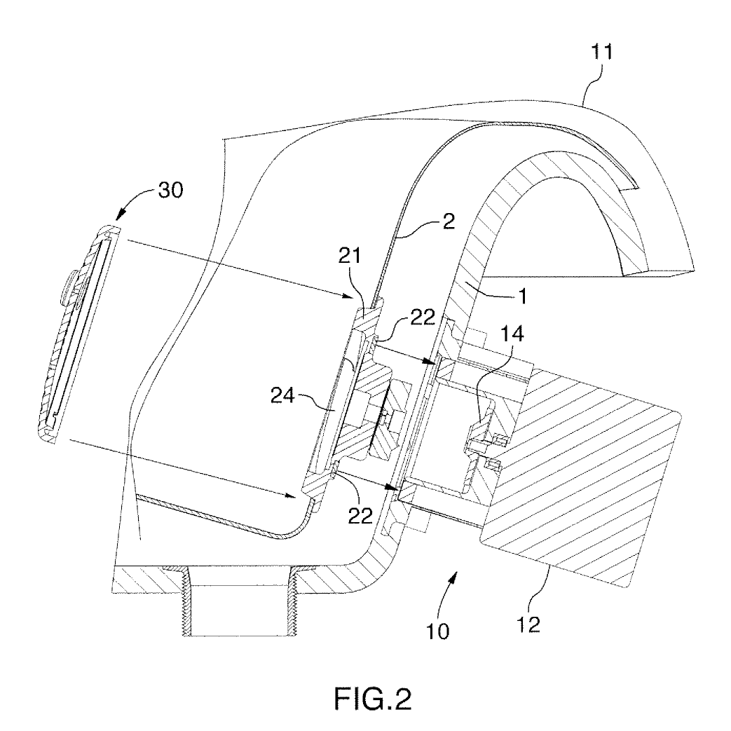

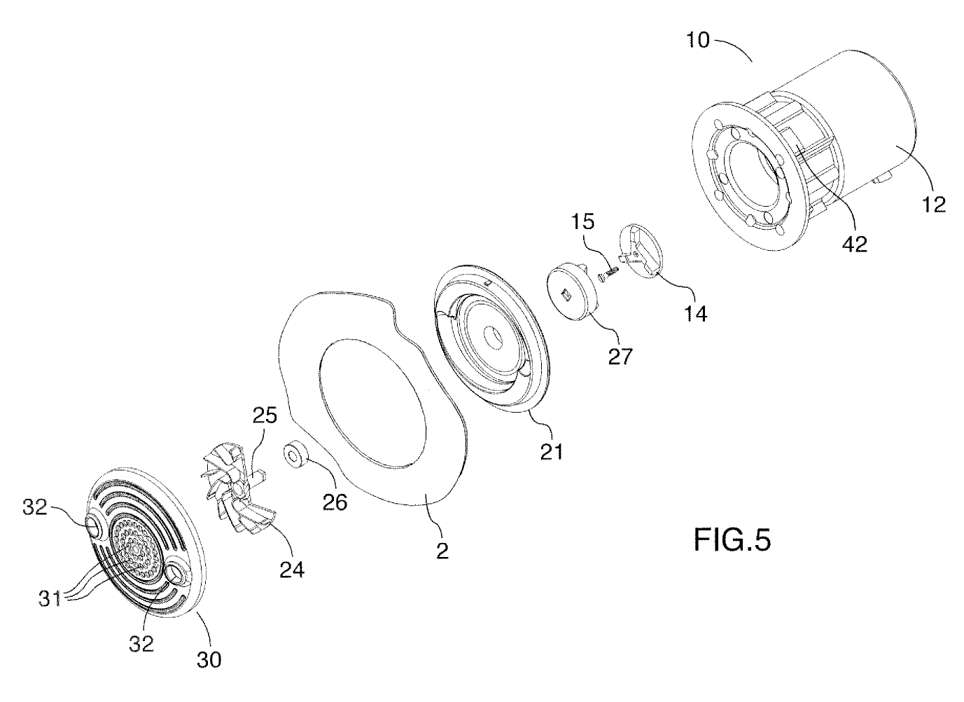

In the preferred embodiment, as shown in FIGS. 2 and 3, a pump assembly 10 is mounted on a wall 11 of the tub. The pump assembly includes an electric motor 12 which drives a drive element 14 as more clearly shown in FIG. 5. The drive element 14 is secured to the motor driveshaft by any suitable means, such as a screw 15. The liner 2 has an opening aligned with the pump assembly, and that opening is bonded or otherwise sealed around its periphery against a flange of an impeller housing 21. The impeller housing in turn attaches to the pump assembly by any suitable means, preferably a readily releasable means such as by the use of magnets 22. The impeller housing contains an impeller 24, with a shaft 25 extending therefrom through a seal 26. The shaft is secured to a coupling 27 (by a press fit and glue, or by any other suitable means), and the coupling 27 which is engaged by the drive element 14 to rotate the impeller. A cover plate 30 having impeller inlets 31 and outlets 32 attaches to the impeller housing on the tub side of the liner. Thus the entire tub liner, cover plate, impeller and impeller housing may be removed and disposed of after use.

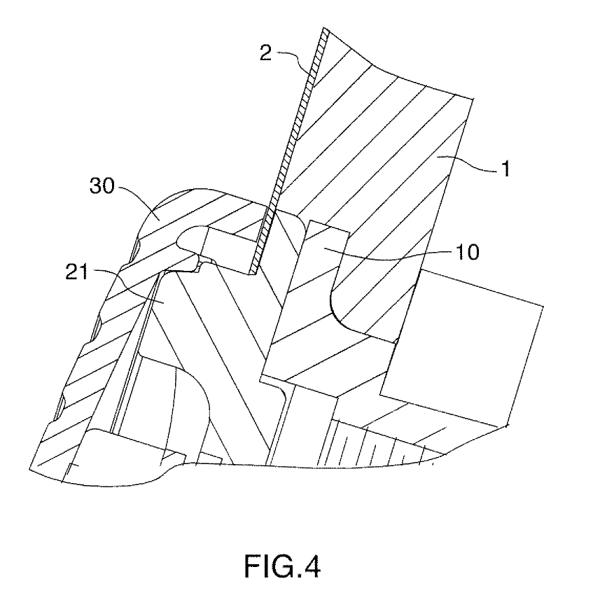

FIG. 4 shows a detail of the liner 2 sealed against the impeller housing 21, with the impeller housing secured against the pump assembly 10. It can be seen that there is no route for water to get into the pump assembly.

FIG. 5 shows the main components of both the pump assembly and impeller assembly. The pump assembly 10 and the drive element 14 are installed in the tub wall, and are not disposable. The remaining elements are intended to be disposed of after each use, i.e. the cover plate 30, the impeller 24, the seal 26, the liner 2, the impeller housing 21, and the coupling 27.

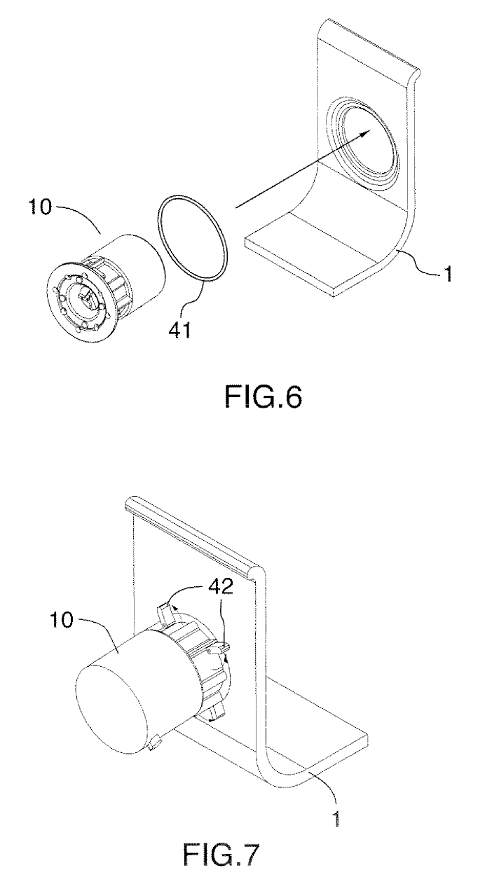

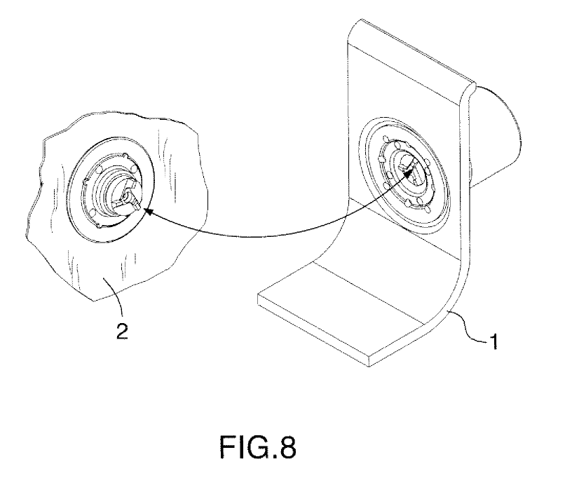

FIGS. 6 and 7 show how the pump assembly 10 is or may be mounted in the wall of the tub. The pump assembly is inserted in an opening 40 in the wall of the tub, sealed by an O-ring 41. As seen in FIG. 7, several arms 42 fold out from the pump assembly to secure it in position, with the O-ring compressed.

Preferred and exemplary embodiments of this invention are described herein. Variations of those embodiments may become apparent to those of ordinary skill in the art upon reading the foregoing description. It is expected that skilled persons will employ such variations as appropriate, and it is expected that the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

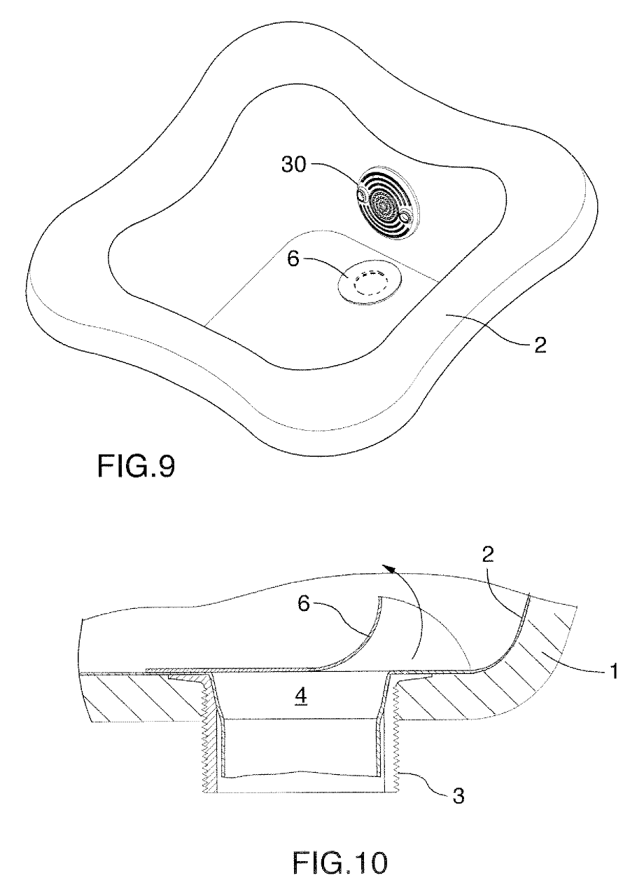

Without limiting the generality of the foregoing statement, a specific example is that the drain, if there is one, could be sealed by any suitable means instead of via a conventional drain plug. As a specific example of an alternative, shown in FIGS. 9 and 10, the liner may have a plastic flap 6 which extends over the opening 4 and is simply held in place by the weight of water in the tub. The flap can simply be lifted to drain the tub.

Further variations may be apparent or become apparent to those knowledgeable in the field of the invention, and are within the scope of the invention as defined by the claims which follow.

1. A bath assembly, comprising a tub and a disposable plastic liner configured to the shape of the tub.

2. A bath assembly as in claim 1, wherein said tub has a drain, and wherein said liner has an opening aligning with the drain of the tub.

3. A bath assembly as in claim 2, wherein said liner has a somewhat tubular portion at said opening, to extend at least partially into the tub drain.

4. A bath assembly as in claim 1, further comprising:
a pump assembly mounted in a wall of the tub, said pump assembly having an electric motor driving a drive element;
an impeller assembly securable to the pump assembly, having an impeller housing with an impeller driven by engagement of a coupling with said drive element to rotate the impeller;
an opening in said liner aligned with said pump assembly and impeller assembly, said opening being sealed around its periphery against said impeller assembly; and
a cover plate having impeller inlets and outlets, said cover plate securable to said impeller housing on a tub side of the liner;
whereby the tub liner, cover plate, and impeller assembly may be removed and disposed of after use.

5. A bath assembly as in claim 4, wherein said impeller assembly is secured to the pump assembly by magnets.

6. A disposable assembly for the tub of a bathe comprising a flexible plastic liner, the liner having an opening aligning with a drain of the tub.

7. A disposable assembly as in claim 6, wherein said liner has a somewhat tubular portion at said opening, to extend at least partially into the tub drain.

8. A disposable assembly as in claim 6, further comprising:
an impeller assembly securable to a pump assembly mounted in a wall of the tub, said pump assembly having an electric motor driving a drive element, said impeller assembly having an impeller housing with an impeller driven by engagement of a coupling with said drive element to rotate the impeller;
an opening in said liner aligned with said pump assembly and impeller assembly, said opening being sealed around its periphery against said impeller assembly; and
a cover plate having impeller inlets and outlets, said cover plate securable to said impeller housing on a tub side of the liner;
whereby the tub liner, cover plate, and impeller assembly may be removed and disposed of after use.
